(19) United States
(12) Patent Application Publication
(10) Pub. No.: US 2022/0118644 A1
(43) Pub. Date: Apr. 21, 2022

(54) METHOD, APPARATUS AND ROTATING CUTTING TOOLS FOR PROFILING EDGES OF A PANEL

(71) Applicant: FLOORING INDUSTRIES LIMITED, SARL, Bertrange (LU)

(72) Inventor: Jan DE RICK, Geraardsbergen (BE)

(21) Appl. No.: 17/421,137

(22) PCT Filed: Dec. 19, 2019
(86) PCT No.: PCT/IB2019/061121

§ 371 Date: Jul. 7, 2021

Related U.S. Application Data
(60) Provisional application No. 62/789,781, filed on Jan. 8, 2019.

(51) Int. Cl. B27F 1/06; F16B 5/00

(52) U.S. Cl. CPC B27F 1/06; F16B 5/0012

(57) ABSTRACT

A method and apparatus for profiling edges of panels, includes using rotating cutting tools. The rotating cutting tools include a first group of teeth with a first form and a second group of teeth with a second, different form.

The present invention relates to a method, an apparatus and rotating cutting tools for profiling edges of a panel.

More specifically, the invention relates to a method of the type wherein the panel comprises a first interlocking profile on a first edge and comprises a second interlocking profile on a second, opposite edge, which first and second interlocking profile are configured to cooperate and thus to realize mechanical interlocking between two such panels; wherein the first interlocking profile is configured in the form of a tongue; wherein the tongue comprises, on the upper side thereof, a vertically active interlocking surface and, on the underside thereof, an interlocking groove with a horizontally active interlocking surface; wherein the second interlocking profile is configured in the form of a groove; wherein the groove is bounded by an upper and lower lip; wherein the upper lip comprises, on the underside thereof, a vertically active interlocking surface that is configured to cooperate with the vertically active interlocking surface on the upper side of the tongue and thus to realize a vertical interlocking between two such panels; wherein the lower lip comprises, on the upper side thereof, an interlocking element with a horizontally active interlocking surface that is configured to cooperate with the horizontally active interlocking surface in the interlocking groove and thus to realize a horizontal interlocking; and wherein the method comprises at least the following steps:

moving the panel into a feeding device (FD) with the first edge relative to a first tool device comprising a first and second rotating cutting tool and with the second edge relative to a second tool device comprising a third and fourth rotating cutting tool;
forming a first and second, different subcontour of the tongue by means of the first and second rotating cutting tool, respectively, wherein the first subcontour comprises the horizontally active interlocking surface of the tongue and the second subcontour comprises the vertically active interlocking surface of the tongue; and
forming a third and fourth, different subcontour of the groove by means of the third and fourth rotating cutting tool, respectively, wherein the third subcontour comprises the horizontally active interlocking surface of the groove and the fourth subcontour comprises the vertically active interlocking surface of the groove.

A method of this type is known and is for example described in the document WO 97/47834 for floor panels of the laminate type to be installed in a floating manner.

A general problem with this known method, primarily in cases where it is used in a panel that comprises a core or core layer out of hard and/or brittle materials, such as highly-filled and/or rigid plastic materials, is that the rotating cutting tools act on the edges of the panel with a significant impact or friction, possibly resulting in all kinds of detrimental effects, such as a fairly high energy consumption by the rotating cutting tools, which means for example that the capacity of the line cannot always be utilized in an optimal manner.

A known solution is to increase the number of rotating cutting tools that are used to form the interlocking profiles. In fact, this makes it possible to insure that per cutting tool, less material has to be removed, less impact/friction will be generated, and the energy consumption per cutting tool can therefore be reduced. However, more cutting tools means that more room is required in order to provide space for all these tools, which is not always possible, and all this does not necessarily result in reduced total energy consumption, but sometimes even the contrary.

The aim of the present invention is to overcome the abovementioned and other drawbacks, and its particular object is to reduce the impact with which the rotating cutting tools act on the edges of the panel, so that, more specifically, reduced or more balanced energy consumption by the rotating cutting tools can be achieved.

To this end, in accordance with a first aspect thereof, the invention relates to a method of the abovementioned type, characterized in that at least one of the abovementioned rotating cutting tools comprises a first group of teeth with a first form and a second group of teeth with a second, different form, so that different parts of the contour of the respective interlocking profile are formed with the teeth of the first and second group. It is clear that the “respective interlocking profile” refers to the interlocking profile that is partly formed by the at least one rotating cutting tool. As the at least one rotating cutting tool, i.e. the rotating cutting tool comprising the first and second group of teeth, comprises teeth with a different form, this gives rise to new possibilities of reducing the impact/friction of this rotating cutting tool on the respective edge. In the rotating cutting tools of the prior art, each tooth has the same form, so that each tooth causes an equal impact on the edge of the panel. In accordance with this first aspect of the invention, because not every tooth has the same form, one can make the choice of having some teeth form not the entire respective subcontour, but only a limited part or piece thereof, thus causing less impact/friction. The at least one rotating cutting tool thus need not consume as much energy, making it possible for example to optimally utilize the line capacity.

It is noted that a “subcontour” is understood to be a part or piece of the final contour of the respective interlocking profile.

The first and second subcontour, or the third and fourth subcontour, together do not necessarily have to form the entire final contour of the first or second interlocking profile respectively. It is thus possible for the final contour of the first or second interlocking profile to also comprise other pieces or parts in addition to the abovementioned subcontours, which for example are formed with other tools.

“Different parts” or “different pieces” of a contour or subcontour are understood to be parts or pieces that, while not identical, can be overlapping. Therefore, the different parts or pieces of the contour or subcontour need not necessarily be separate, and thus non-overlapping, parts or pieces.

It is not excluded for a “group of teeth” to consist of only one tooth. Preferably, however, a group comprises several teeth. The several teeth of one and the same group are preferably identical in form.

Preferably, only a limited part of the respective subcontour is formed with the teeth of the second group. In other words, the entire respective subcontour is not formed with the teeth of the second group. It is clear that the “respective subcontour” refers to the subcontour that is formed with the at least one rotating cutting tool. As the teeth of the second group form only a limited part of the respective subcontour, this provides the advantage that the impact with which the at least one rotating cutting tool acts on the respective edge can be reduced, and the energy composition of this tool can therefore be reduced. However, this also means that another part of the respective subcontour is not treated by the teeth of the second group. Although this can be detrimental to the precision with which this other part is formed, a possible adverse effect can be limited for example in that the untreated part of the respective subcontour is intended to be used in order to enclose a space or an air space in the interlocked state of the panels. With such zones of the contours of the interlocking profiles, extremely high precision is of less importance.

Only a limited part of the respective subcontour can be formed with the teeth of the first group as well. Preferably, however, the entire respective subcontour is formed with the teeth of the first group. This provides the practical advantage that the number of groups of teeth with a different form can be kept limited. The respective subcontour is already completely formed by the teeth of the first group. This makes it possible to limit the total number of groups of teeth with a different form to two or three, although the use of more than three groups of teeth with a different form is not excluded.

Preferably, the respective interlocking surface is formed with the teeth of both the first and the second groups. It is clear that the “respective interlocking surface” refers to the interlocking surface that is formed by the at least one rotating cutting tool, comprising the first and second group of teeth. As the respective interlocking surface is treated or formed by the teeth of both the first and the second group, this interlocking surface can be produced with high precision. Indeed, the greater the number of teeth that treat or form a certain surface, the more precisely this surface is formed and the lower the production tolerances are. This is of particular importance in the case of an interlocking surface because in this way, one can minimize the risk of occurrence of cracks or the occurrence of height differences between the interlocked panels.

It is possible for different and non-overlapping parts of the respective subcontour to be formed with the teeth of the first and second group. In other words, the part of the respective subcontour that is formed with the teeth of the first group is different from and does not overlap with the part of the respective subcontour that is formed with the teeth of the second group. This is advantageous in that a balanced distribution of the amount of material to be removed can be achieved, which allows the impact created by the at least one rotating cutting tool to be reduced and for example allows the line capacity to be optimally utilized. This measure can have a detrimental effect on the precision with which the respective parts of the subcontour are formed, as only one of the first and second group of teeth treats the respective parts, but it can nevertheless be useful in applications in which a high line speed is important.

In a practical example, the at least one rotating cutting tool comprises a tooth sequence that repeats along at least a part of the circumference of the at least one rotating cutting tool, which tooth sequence comprises a tooth from both the first and the second group. This is an efficient and practical way of configuring the at least one rotating cutting tool.

The at least one rotating cutting tool can be the first or second rotating cutting tool, and can thus be used to form the first or second subcontour, respectively, of the first interlocking profile of the tongue. It is also possible for both the first and the second rotating cutting tool to be configured in the same way as the at least one rotating cutting tool and therefore to comprise several groups of teeth with a different form. However, the first and/or second rotating cutting tools can also be “classical” rotating cutting tools, i.e. rotating cutting tools whose teeth have an identical form. For forming the tongue, typically less material has to be cut away than for forming the groove. The rotating cutting tools that are used for forming the tongue consequently have less of an impact on the respective edge of the panel. For this reason, it may be sufficient to use classical rotating cutting tools with a view to the energy consumption and/or the optimal utilization of the line speed or line capacity.

The at least one rotating cutting tool can be the third or fourth rotating cutting tool, and can thus be used to form the third or fourth subcontour, respectively, of the second interlocking profile of the groove. It is also possible for both the third and fourth rotating cutting tool to be configured in the same way as the at least one rotating cutting tool. The use of the at least one rotating cutting tool for forming the groove is particularly useful because, as mentioned above, large amounts of material typically have to be cut away in this case, resulting in a serious impact on the edge. The measures of the first aspect of the invention allow this impact/friction to be reduced, for example with positive effects on the energy consumption of the tool used and on the line speed that can be realized. However, the use of classical rotating cutting tools for the third and/or fourth rotating cutting is not excluded.

It is also noted that several of the rotating cutting tools can be configured as described in connection with the at least one rotating cutting tool, and several of the rotating cutting tools can therefore comprise at least two groups of teeth with a different form.

With the same object as in the first aspect, the invention, in accordance with a second aspect thereof, relates to a method of the abovementioned type, characterized in that, in the first interlocking profile, first the first and then the second subcontour are formed, and/or in the second interlocking profile, first the third and then the fourth subcontour are formed. By applying this specific order, it is found that a more balanced material removal and/or energy consumption by the rotating cutting tools can be obtained.

It is noted that the measures described in connection with the first aspect of the invention can be combined with the measures described in connection with the second aspect of the invention.

The measures described below in the introduction apply to both the first and the second aspect of the invention.

The first rotating cutting tool preferably forms the final contour of a first part of the underside of the tongue and the second rotating cutting tool preferably forms the final contour of a second part of the underside of the tongue and the final contour of the upper side of the tongue.

The third rotating cutting tool preferably forms the final contour of a first part of the upper side of the lower lip and the fourth rotating cutting tool preferably forms the final contour of a second part of the upper side of the lower lip and the final contour of the underside of the upper lip.

The final contour of the first interlocking profile of the tongue is preferably mainly formed by the first and second rotating cutting tool. This allows the number of tools used to be limited.

The final contour of the second interlocking profile of the groove is preferably mainly formed by the third and fourth rotating cutting tool. This allows the number of tools used to be limited.

The first and second rotating cutting tool are preferably arranged at different angles. In this connection, “angle” refers to the angle between the plane of the panel and the plane in which the cutting tool rotates.

The third and fourth rotating cutting tool are preferably arranged at different angles.

The first, second, third and/or fourth rotating cutting tool is preferably a rotating milling tool.

The first and/or second tool device preferably comprises a pre-treatment tool. The pre-treatment tool can be used for the correct positioning of the panel. The pre-treatment tool can be used in order to form at least a part of the abutment surface of the respective interlocking profile. An “abutment surface” is understood to refer to a surface of the interlocking profile that is configured to abut against a corresponding abutment surface of the interlocking profile cooperating therewith, so that a continuous surface is formed by the interlocked panels. The abutment surface is typically situated on the upper side of the panel, optionally under a chamfer or bevel that is arranged on the upper side of the panel. By using a pre-treatment tool, the workload of the rotating cutting tools can be reduced. Indeed, this pre-treatment tool can already remove a part of the material to be removed, which results in a more balanced distribution and can reduce the energy consumption of the other tools. The pre-treatment tool can be what is referred to in technical terms as a “post-milling cutter.”

The pre-treatment tool is preferably a rotating cutting or milling tool.

The first and/or second tool device preferably comprises a finishing tool. The finishing tool can be used to provide the respective edge of the panel on the upper side thereof with a bevel or chamfer. The finishing tool can be a cutting tool, such as a knife. It is preferably not a rotating cutting tool. The reason for this is that, in this application, a rotating cutting tool can produce a shiny bevel or chamfer, which is not desired.

The finishing tool can be used in order to remove an amount of material in addition to the possible forming of the bevel or chamfer, in such a way that a more balanced energy consumption over the different tools used can be obtained. This idea is an independent inventive idea of the invention. Therefore, the invention, in accordance with a third aspect thereof, relates to a method of the abovementioned type, characterized in that the first and/or second tool device comprises a finishing tool that removes an amount of material from the respective edge of the panel, in addition to the possible forming on the respective edge of a bevel or chamfer near the upper side of the panel. It is noted that the measures described in connection with the first and second aspect of the invention can also be applied in this third aspect of the invention.

A fourth aspect of the invention relates to an apparatus for profiling edges of a panel, wherein the panel, after this profiling, comprises a first interlocking profile on a first edge and a second interlocking profile on a second, opposite edge, which first and second interlocking profile are configured to cooperate and thus to realize mechanical interlocking between two such panels; wherein the first interlocking profile is configured in the form of a tongue; wherein the tongue comprises, on the upper side thereof, a vertically active interlocking surface and on the underside thereof an interlocking groove with a horizontally active interlocking surface; wherein the second interlocking profile is configured in the form of a groove; wherein the groove is bounded by an upper and lower lip; wherein the upper lip comprises, on the underside thereof, a vertically active interlocking surface that is configured to cooperate with the vertically active interlocking surface on the upper side of the tongue and thus to realize a vertical interlocking between two such panels; wherein the lower lip comprises, on the upper side thereof, an interlocking element with a horizontally active interlocking surface that is configured to cooperate with the horizontally active interlocking surface in the interlocking groove and thus to realize a horizontal interlocking. The apparatus comprises at least:

a first tool device comprising a first and a second rotating cutting tool;
a second tool device comprising a third and a fourth rotating cutting tool; and
means for moving the panel into a feeding device with the first edge relative to the first tool device and with the second edge relative to the second tool device.

The first rotating cutting tool and the second rotating cutting tool are provided for forming a first and second, different subcontour of the tongue by means of the first and second rotating cutting tool, respectively, wherein the first subcontour comprises the horizontally active interlocking surface of the tongue and the second subcontour comprises the vertically active interlocking surface of the tongue. The third rotating cutting tool and the fourth rotating cutting tool are provided for forming a third and fourth, different subcontour of the groove respectively by means of the third and fourth rotating cutting tool. The third subcontour comprises the horizontally active interlocking surface of the groove. The fourth subcontour comprises the vertically active interlocking surface of the groove. The apparatus is characterized in that at least one of the abovementioned rotating cutting tools comprises a first group of teeth with a first form and a second group of teeth with a second, different form, so that different parts of the contour of the respective interlocking profile are formed with the teeth of the first and second group.

It is not excluded for a “group of teeth” to consist only of one tooth. Preferably, however, a group comprises several teeth. The several teeth of one and the same group are preferably identical in form.

The teeth of the second group are preferably provided in order to form only a limited part of the respective subcontour.

The teeth of the first group are preferably provided for forming the entire respective subcontour.

The teeth of the first and of the second group are preferably provided in order to form the respective interlocking surface together.

Preferably, this at least one rotating cutting tool comprises at least three groups of teeth, each having at least two teeth, and preferably each having four teeth.

Preferably, the at least one rotating cutting tool comprises a tooth sequence that repeats along at least a part of the circumference of the at least one rotating cutting tool, which tooth sequence comprises a tooth from both the first and the second group.

Preferably, the at least one rotating cutting tool is the first and/or the second rotating cutting tool.

Preferably, the at least one rotating cutting tool is the third and/or the fourth rotating cutting tool.

Preferably, the first rotating cutting tool is provided for forming the final contour of a first part of the underside of the tongue. Wherein the second rotating cutting tool is provided for forming the final contour of the upper side of the tongue and the final contour of a second part of the underside of the tongue.

Preferably, the third rotating cutting tool is provided for forming the final contour of a first part of the upper side of the lower lip. The fourth rotating cutting tool is provided for forming the final contour of the underside of the upper lip and the final contour of a second part of the upper side of the lower lip.

Preferably, the first and second rotating cutting tool are provided for mainly forming the final contour of the first interlocking profile.

Preferably, the third and fourth rotating cutting tool are provided for mainly forming the final contour of the second interlocking profile.

Preferably, the first and second rotating cutting tool are arranged at different angles.

Preferably, the third and fourth rotating cutting tool are arranged at different angles.

Preferably, the first, second, third and/or fourth rotating cutting tool is a rotating.

Preferably, the first and/or second tool device comprises a pre-treatment tool, by means of which preferably at least a part of an abutment surface of the respective interlocking profile is formed. More preferably, the pre-treatment tool is a rotating cutting or milling tool.

Preferably, the first and/or second tool device comprises a finishing tool, preferably for the forming on the respective edge of a bevel or chamfer adjacent to the upper side of the panel. More preferably, the finishing tool is provided for the removal of an amount of material, in addition to the possible forming of the bevel or chamfer.

The fifth aspect of the invention relates to a rotating cutting tool suitable for use as a first, second, third or fourth rotating cutting tool in an apparatus such as in the fourth aspect of the invention or in a method such as in the first, second or third aspect of the invention. The rotating cutting tool comprises a first group of teeth with a first form and a second group of teeth with a second, different form, so that different parts of the contour of an interlocking profile can be formed with the teeth of the first and second group.

It is not excluded for a “group of teeth” to consist of only one tooth. Preferably, however, a group comprises several teeth. The several teeth of one and the same group are preferably identical in form.

The sixth aspect of the invention relates to a rotating cutting tool for forming a profile on an edge of a panel. The rotating cutting tool comprises a first group of teeth with a first form and a second group of teeth with a second, different form.

Preferably, this rotating cutting tool is a rotating milling tool.

It is not excluded for a “group of teeth” to consist of only one tooth. Preferably, however, a group comprises several teeth. The several teeth of one and the same group are preferably identical in form.

The teeth of the first group of teeth and the teeth of the second group of teeth are provided in order to form the profile together.

The first group of teeth and the second group of teeth are each preferably provided for forming a part of the contour of the profile.

Preferably, the first group of teeth and the second group of teeth are provided for forming different parts of the contour of the profile.

Preferably, the rotating cutting tool comprises a tooth sequence that repeats along at least a part of its circumference. This tooth sequence comprises a tooth from both the first and the second group.

Preferably, the rotating cutting tool comprises at least three groups of teeth, each having at least two teeth, and preferably each having four teeth.

The invention can be applied in panels that comprise a core or core layer made of any desired materials, such as wood materials, wood-based materials, for example wood fiberboard, in particular LDF (low density fiberboard), MDF (medium density fiberboard) or HDF (high density fiberboard), or wood particle board, bamboo materials, plastic materials, thermoplastic materials, for example polyvinyl chloride (PVC), in particular flexible, semi-rigid or rigid PVC, polyethylene (PE), polypropylene (PP), thermoplastic polyurethane (PU) or polyethylene terephthalate (PET), thermosetting materials, such as thermosetting polyurethane (PU), ceramic materials, mineral materials, stone or stone-like materials, fiber cement plate or magnesium oxide (MgO) plate.

In the context of this invention, “rigid PVC” is understood to be PVC without a plasticizer or with an amount of plasticizer of less than 5 phr, “semi-rigid PVC” is understood to be PVC with an amount of plasticizer of between 5 and 15 phr, and “flexible PVC” is understood to be PVC with an amount of plasticizer of more than 15 phr. “Phr” is the abbreviation for the English “parts per hundred resin.” An amount of plasticizer of less than 5 phr indicates for example that fewer than 5 parts of plasticizer are present per 100 parts of PVC.

The invention is used particularly advantageously in panels that comprise a core or core layer out of fairly hard and/or brittle materials. Examples of such materials are highly-filled plastic materials, rigid or semi-rigid plastic materials, such as rigid or semi-rigid PVC, high-density materials, such as materials with an average density of at least 1000, at least 1500 or at least 1750 kilograms per cubic meter, ceramic materials, mineral materials, stone or stone-like materials, fiber cement plate, magnesium oxide plate and the like. In the case of these materials in particular, the pressures exerted by the cutting tools can be quite high. For this reason, the measures in accordance with the invention are extremely useful in this case.

“Highly-filled plastic material” is understood to be plastic material that comprises a portion of filler of at least 40 percent by weight based on the total weight of the plastic material. Preferably, the plastic material comprises an amount of filler of at least 50 percent by weight, at least 60 percent by weight or at least 70 percent by weight based on the total weight of plastic material.

Examples of fillers that can be used in plastic materials are: mineral fillers, stone or stone-like fillers, calcium carbonate, chalk, lime or limestone, talc, magnesium, magnesium oxide, etc.

The panel is preferably a decorative panel. A “decorative panel” is understood to be a panel that shows, on the upper side thereof, a decor, such as a wood, stone, or imaginative decor. The decor can be formed by natural materials, such as wood or wood veneer. However, the decor can also be a printed decor that for example simulates a natural decor, such as a wood or stone decor. In this case, the decor can be printed on a substrate that is bonded to a core of the panel or can be directly printed on a core of the panel. In the latter case, one speaks of a “direct print,” wherein it is not excluded for the print to be applied to a base layer or primer present on the core. Some examples of the abovementioned decor substrates are: paper layers, whether or not impregnated with resin, and plastic films, for example PVC films. Above the decor, a transparent wear layer may be provided, with the intended function of protecting the decor against wear. Examples of wear layers are: lacquer layers, paper layers, whether or not impregnated with resin, and plastic films, such as PVC films.

The invention can be applied in any panels, such as floor, wall or door panels, but it is exceptionally suitable for floor applications.

The first and/or second interlocking profile is preferably configured to consist mainly of the material of the panel and to form an integral piece therewith, more specifically to consist mainly of the material of a core or core layer of the panel and to form an integral piece therewith.

The interlocking profiles can be of the turning type. Interlocking profiles of the “turning type” are interlocking profiles that allow the panels to be interlocked with one another at the respective edges by means of a turning or rotating motion of one panel with respect to the other panel, with or without the occurrence of a click-fit or snap-fit effect.

The interlocking profiles can be of the sliding type. Interlocking profiles of the “sliding type” are interlocking profiles that allow the panels to be interlocked with one another at the respective edges by means of a sliding motion of one panel with respect to the other, more specifically a translational movement in the horizontal direction, typically with the occurrence of a click-fit or snap-fit effect.

The interlocking profiles can be configured to fit into one another with tolerance or to fit precisely. However, the interlocking profiles can also fit into one another with pretensioning. That the interlocking profiles fit into one another “with pretensioning” means that one profile does not fit exactly into the other, so that the profiles fit into one another clampingly. In an interlocking tongue-and-groove connection, such pretensioning can be realized for example by the fact that the lower lip is bent in an interlocked state, so that this lip generates a retroactive or rebound force that presses the interlocked panels against one another. The use of pretensioning is particularly advantageous in this invention because it helps to absorb tolerances, which can be somewhat greater in the invention, for example because not each tooth of the cutting tool described herein forms the entire subcontour. The technology of pretensioning can help to absorb these tolerances, so that panels are obtained wherein the risk of gaps occurring between the interlocked panels is minimized.

It is furthermore noted that a “vertical interlocking” is understood to be a mechanical interlocking that is active in the vertical direction or in the direction perpendicular to the plane of the interlocked panels. A “horizontal interlocking” is understood to be a mechanical interlocking that is active in the horizontal direction or in the direction in the plane of the interlocked panels and perpendicular to the respective edges.

It is also noted that each of the interlocking surfaces introduced in this text may be flat or curved.

In order to better illustrate the characteristics of the different aspects of the invention, several preferred embodiments are described below as examples that are by no means limitative, with reference to the attached drawings, in which:

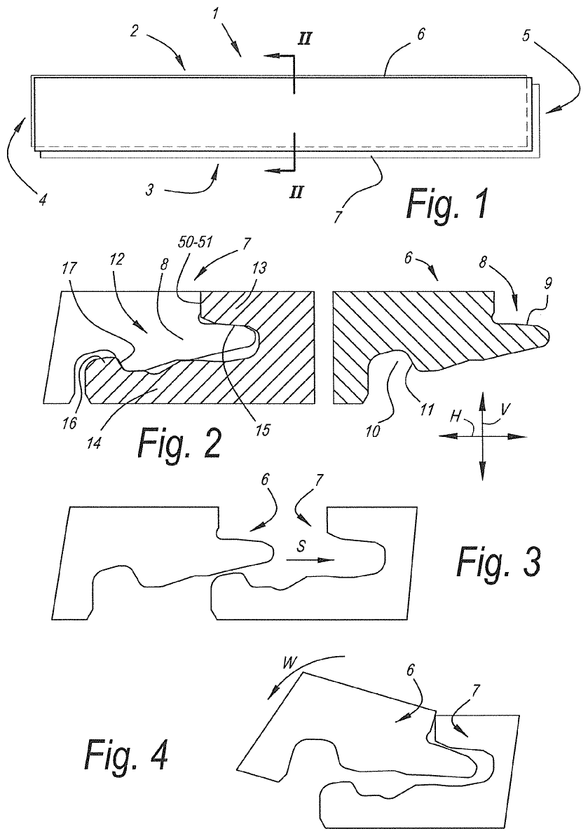

FIG. 1 shows a top view of a panel, more specifically a floor panel, wherein the edges of this panel are profiled by methods in accordance with the invention;

FIG. 2 shows an expanded cross-sectional view along line II-II in FIG. 1;

FIGS. 3 and 4 show how such panels can be coupled;

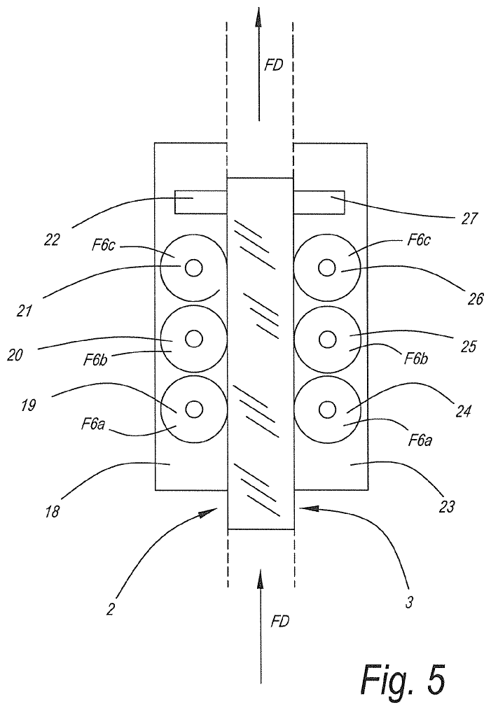

FIG. 5 shows a method and an apparatus in accordance with the invention, wherein this method and this apparatus are used for profiling the edges of the panel of FIG. 1;

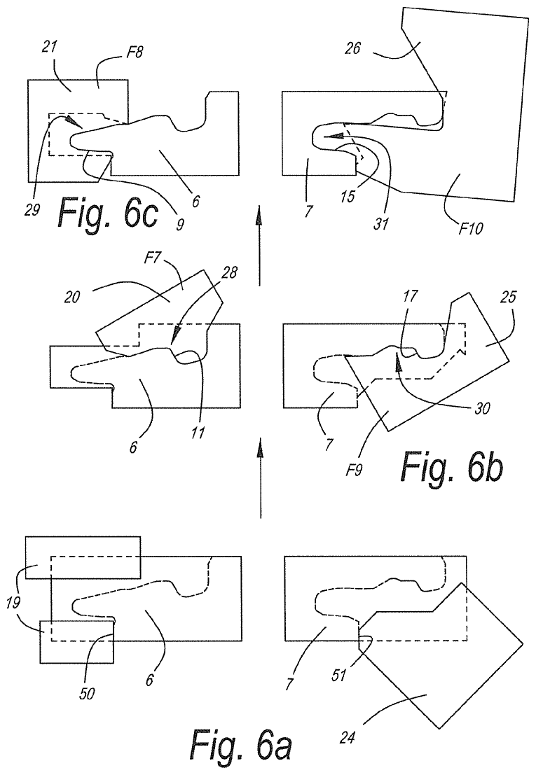

FIGS. 6a, 6b and 6c show cross-sectional views on a larger scale of the way in which the cutting tools denoted by the reference symbols F6a, F6b and F6c act on the edges of the panel; and

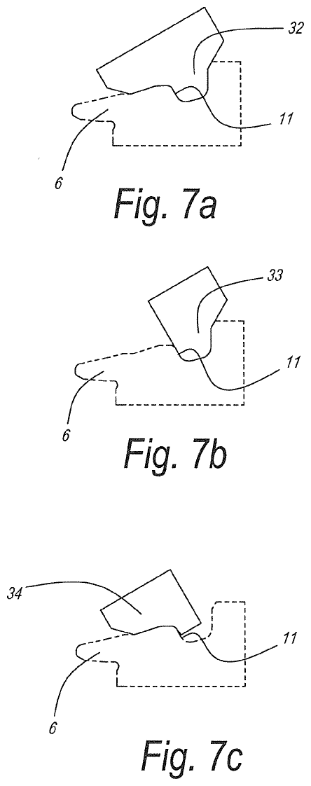

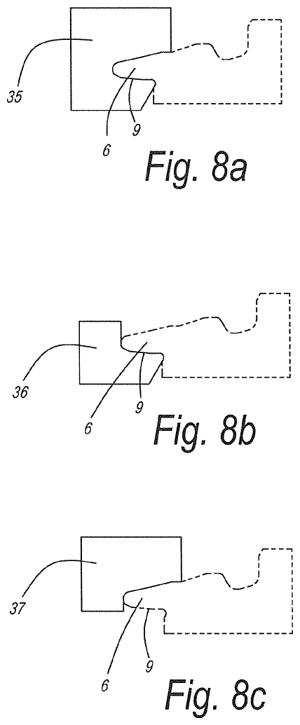

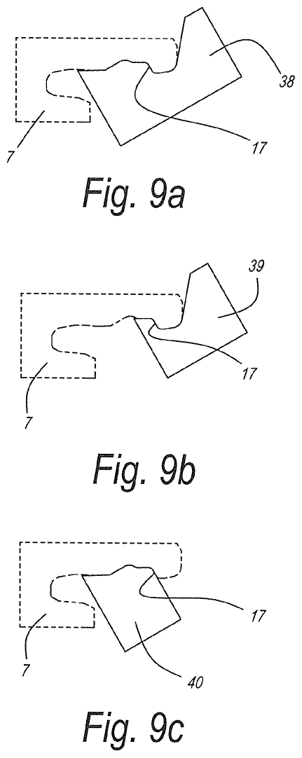

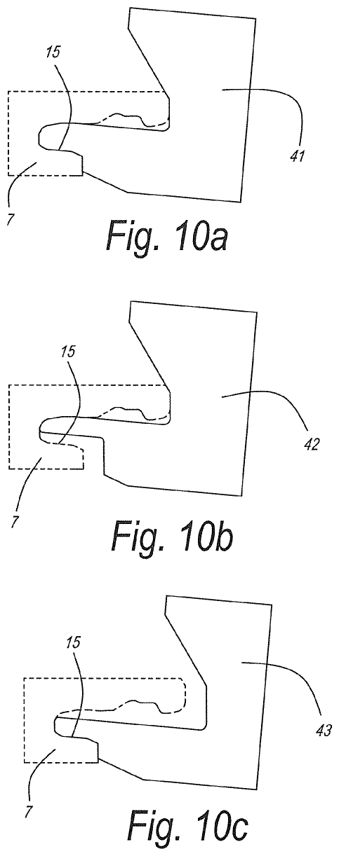

FIGS. 7 to 10 each show one tooth of the three groups of teeth from which the rotating cutting tools denoted by the reference symbols F7 to F10 are constructed, wherein the teeth 32-34, the teeth 35-37, the teeth 38-40 and the teeth 41-43 each form a tooth sequence that repeats along the circumference of the respective rotating cutting tool, in particular four times, so that each of the respective rotating cutting tools comprises twelve teeth.

The figures illustrate—as an example of the different aspects of the invention—a method and an apparatus for profiling edges of a panel. The panel (1) comprises a first interlocking profile (6) on a first edge (2) and a second interlocking profile (7) on a second, opposite edge (3). The first and second interlocking profile (6-7) are configured to cooperate and thus to realize mechanical interlocking between two such panels (1). The first interlocking profile (6) is configured in the form of a tongue (8). The tongue (8) comprises, on the upper side thereof, a vertically active interlocking surface (9) and, on the underside thereof, an interlocking groove (10) with a horizontally active interlocking surface (11). The second interlocking profile (7) is configured in the form of a groove (12). The groove (12) is bounded by an upper and lower lip (13-14). The upper lip (13) comprises, on the underside thereof, a vertically active interlocking surface (15) that is configured to cooperate with the vertically active interlocking surface (9) on the upper side of the tongue (8) and thus to realize a vertical interlocking between two such panels. The lower lip (14) comprises, on the upper side thereof, an interlocking element (16) with a horizontally active interlocking surface (17) that is configured to cooperate with the horizontally active interlocking surface (11) in the interlocking groove (10) and thus to realize a horizontal interlocking. The method comprises at least the following steps:

moving the panel (1) into a feeding device (FD) with the first edge (2) relative to a first tool device (18) comprising a first and second rotating cutting tool (20-21) and with the second edge (3) relative to a second tool device (23) comprising a third and fourth rotating cutting tool (25-26); forming a first and second, different subcontour (28-29) of the tongue (8) respectively by means of the first and second rotating cutting tool (20-21), wherein the first subcontour (28) comprises the horizontally active interlocking surface (11) of the tongue (8) and the second subcontour (29) comprises the vertically active interlocking surface (9) of the tongue (8); and
forming a third and fourth, different subcontour (30-31) of the groove (12) respectively by means of the third and fourth rotating cutting tool (25-26), wherein the third subcontour (30) comprises the horizontally active interlocking surface (17) of the groove (12) and the fourth subcontour (31) comprises the vertically active interlocking surface (15) of the groove (12).

At least one of the abovementioned rotating cutting tools (20-21, 25-26) comprises a first group of teeth (32, 35, 38, 41) with a first form and a second group of teeth (33, 36, 39, 43) with a second, different form, so that different parts of the contour of the respective interlocking profile are formed with the teeth of the first and second group.

The respective interlocking surface is formed with the teeth of both the first and the second group (32, 33, 35, 36, 38, 39, 41, 43).

The at least one rotating cutting tool comprises at least three groups of teeth (32-43) each having at least two teeth, and preferably each having four teeth.

The first and second rotating cutting tool are arranged at different angles. The third and the fourth rotating cutting tool are arranged at different angles.

The first, second, third and/or fourth rotating cutting tool are rotating milling tools.

The first and the second tool device comprise pre-treatment tools (19, 24), by means of which at least a part of an abutment surface (50, 51) of the respective interlocking profile (6, 7) is formed. The pre-treatment tools (19, 24) are rotating milling tools.

The first and the second tool device comprise finishing tools (22, 27), by means of which a chamfer is formed on the respective edge near the upper side of the panel. In the example, the finishing tools (22, 27) remove an amount of material in addition to forming the chamfer. The finishing tools (22, 27) are rotating milling tools.

The present invention is by no means limited to the above-described embodiments, but such methods, apparatuses and cutting tools can be realized in accordance with different variants without departing from the scope of the present invention.

1.-60. (canceled)

61. A method for profiling edges of a panel, wherein the panel comprises a first interlocking profile on a first edge and a second interlocking profile on a second, opposite edge, which first and second interlocking profile are configured to cooperate and thus to realize mechanical interlocking between two such panels;
wherein the first interlocking profile is configured in the form of a tongue;
wherein the tongue comprises, on the upper side thereof, a vertically active interlocking surface and, on the underside thereof, an interlocking groove with a horizontally active interlocking surface;
wherein the second interlocking profile is configured in the form of a groove;
wherein the groove is bounded by an upper and lower lip;
wherein the upper lip comprises, on the underside thereof, a vertically active interlocking surface that is configured to cooperate with the vertically active interlocking surface on the upper side of the tongue and thus to realize a vertical interlocking between two such panels;
wherein the lower lip comprises, on the upper side thereof, an interlocking element with a horizontally active interlocking surface that is configured to cooperate with the horizontally active interlocking surface in the interlocking groove and thus to realize a horizontal interlocking; and wherein the method comprises at least the following steps:
moving the panel into a feeding device with the first edge relative to a first tool device comprising a first and second rotating cutting tool and with the second edge relative to a second tool device comprising a third and fourth rotating cutting tool;
forming a first and second, different subcontour of the tongue by means of the first and second rotating cutting tool, respectively, wherein the first subcontour comprises the horizontally active interlocking surface of the tongue and the second subcontour comprises the vertically active interlocking surface of the tongue; and
forming a third and fourth, different subcontour of the groove by means of the third and fourth rotating cutting tool, respectively, wherein the third subcontour comprises the horizontally active interlocking surface of the groove nd the fourth subcontour comprises the vertically active interlocking surface of the groove;
wherein at least one of the abovementioned rotating cutting tools comprises a first group of teeth with a first form and a second group of teeth with a second, different form, so that different parts of the contour of the respective interlocking profile are formed with the teeth of the first and second group.

62. The method in accordance with claim 61, wherein only a limited part of the respective subcontour is formed with the teeth of the second group.

63. The method in accordance with claim 61, wherein the entire respective subcontour is formed with the teeth of the first group.

64. The method in accordance with claim 61, wherein the respective interlocking surface is formed with the teeth of both the first and the second group.

65. The method in accordance with claim 61, wherein the at least one rotating cutting tool comprises at least three groups of teeth, each having at least two teeth, or each having four teeth.

66. The method in accordance with claim 61, wherein the at least one rotating cutting tool comprises a tooth sequence that repeats along at least a part of the circumference of the at least one rotating cutting tool, which tooth sequence comprises a tooth from both the first and the second group.

67. The method in accordance with claim 61, wherein the at least one rotating cutting tool is the first and/or the second rotating cutting tool.

68. The method in accordance with claim 61, wherein the at least one rotating cutting tool is the third and/or the fourth rotating cutting tool.

69. A method for profiling edges of a panel, wherein the panel comprises a first interlocking profile on a first edge and a second interlocking profile on a second, opposite edge, which first and second interlocking profile are configured to cooperate and thus to realize mechanical interlocking between two such panels;
wherein the first interlocking profile is configured in the form of a tongue;
wherein the tongue comprises, on the upper side thereof, a vertically active interlocking surface and, on the underside thereof, an interlocking groove with a horizontally active interlocking surface;
wherein the second interlocking profile is configured in the form of a groove;
wherein the groove is bounded by an upper and lower lip;
wherein the upper lip comprises, on the underside thereof, a vertically active interlocking surface that is configured to cooperate with the vertically active interlocking surface on the upper side of the tongue and thus to realize a vertical interlocking between two such panels;
wherein the lower lip comprises, on the upper side thereof, an interlocking element with a horizontally active interlocking surface that is configured to cooperate with the horizontally active interlocking surface in the interlocking groove and thus to realize a horizontal interlocking; and wherein the method comprises at least the following steps:
moving the panel into a feeding device with the first edge relative to a first tool device comprising a first and second rotating cutting tool and with the second edge relative to a second tool device comprising a third and fourth rotating cutting tool;
forming a first and second, different subcontour of the tongue by means of the first and second rotating cutting tool, respectively, wherein the first subcontour comprises the horizontally active interlocking surface of the tongue and the second subcontour comprises the vertically active interlocking surface of the tongue; and
forming a third and fourth, different sub contour of the groove respectively by means of the third and fourth rotating cutting tool,
wherein the third subcontour comprises the horizontally active interlocking surface of the groove and the fourth subcontour comprises the vertically active interlocking surface of the groove;
wherein in the first interlocking profile, first the first and then the second subcontour are formed, and/or in the second interlocking profile, first the third and then the fourth subcontour are formed.

70. The method in accordance with claim 61, wherein the first rotating cutting tool forms the final contour of a first part of the underside of the tongue and the second rotating cutting tool forms the final contour of the upper side of the tongue and the final contour of a second part of the underside of the tongue.

71. The method in accordance with claim 61, wherein the third rotating cutting tool forms the final contour of a first part of the upper side of the lower lip and the fourth rotating cutting tool forms the final contour of the underside of the upper lip and the final contour of a second part of the upper side of the lower lip.

72. The method in accordance with one claim 61, wherein the final contour of the first interlocking profile is mainly formed by the first and second rotating cutting tool.

73. The method in accordance with claim 61 wherein the final contour of the second interlocking profile is mainly formed by the third and fourth rotating cutting tool.

74. The method in accordance with claim 61, wherein the first and second rotating cutting tool are arranged at different angles.

75. The method in accordance with claim 61, wherein the first, second, third and/or fourth rotating cutting tool is a rotating milling tool.

76. The method in accordance with claim 61, wherein the first and/or second tool device comprise a pre-treatment tool, by means of which at least a part of an abutment surface of the respective interlocking profile is formed.

77. The method in accordance with claim 76, wherein the pre-treatment tool is a rotating cutting or milling tool.

78. The method in accordance with claim 61, wherein the first and/or second tool device comprises a finishing tool, by means of which a bevel or chamfer is formed on the respective edge near the upper side of the panel.

79. The method in accordance with claim 78, wherein the finishing tool removes an amount of material, in addition to the forming of the bevel or chamfer.

80. The method in accordance with claim 61, wherein the panel comprises a core or core layer that comprises plastic material with an amount of filler of at least 40 percent by weight based on the total weight of plastic material.
